(19) United States
(12) Patent Application Publication
(10) Pub. No.: US 2025/0356223 A1
(43) Pub. Date: Nov. 20, 2025

(54) Machine-Learning Systems and Methods for Conversational Recommendations

(71) Applicant: Google LLC, Mountain View, CA (US)

(72) Inventors: Georgi Stephanov, Pfäffikon Schwyz (CH); Ágoston Weisz, Pfäffikon Schwyz (CH); Manuel Tragut, Zug (CH); Mariia Kliuieva, Zürich (CH); Alessandro Agostini, Zürich (CH); Yury Stuken, Zürich (CH); Ilia Akolzin, Zürich (CH); Fabio Sulser, Zürich (CH)

(21) Appl. No.: 18/666,473

(22) Filed: May 16, 2024

(51) Int. Cl. G06N 5/04

(52) U.S. Cl. CPC G06N 5/04

(57) ABSTRACT

Aspects of the disclosed technology include computer-implemented systems and methods for conversational recommendation systems, such as conversational chatbots that are configured to process user queries and generate responses. A recommendation system includes a conversational user interface configured to receive a user query and provide a recommendation response and a machine-learned sequence processing model that has been trained on training data including a plurality of triplets. Each triplet includes an example query, an example model reasoning plan associated with the example query, and an example response associated with the example query and the example model reasoning plan. The sequence processing model can be trained to provide conversational-based recommendations using a multi-stage recommendation process that includes a planning stage, a conversation stage, and a retrieval stage.

### FIELD

The present disclosure relates generally to machine learning processes and machine-learned devices and systems. More particularly, the present disclosure relates to machine-learned models for conversational recommendation systems.

### BACKGROUND

Artificial intelligence systems increasingly include large foundational machine-learned models which have the capability to provide a wide range of new product experiences. As an example, machine-learned sequence processing models such as large language modes (LLMs) have proven successful at many computing tasks such as providing artificial intelligence (AI) chatbot interactions that include chat-style interfaces and communications. An LLM-based chatbot can receive user queries and provide responses in a conversation manner using natural language. A chat may culminate in an actionable question and/or command. Today's LLM-based chatbots, however, provide limited assistance in determining many factors relative to recommendations to fulfill a user's intent from a user query. As such, the systems tend to be inefficient as users often provide many queries to the system in order to finally receive a response that fulfills their intent. Due to the large memory and processing capacity required to deploy LLM-based systems at scale, these inefficiencies can lead to underperformance of the chatbot and large consumptions of computing resources.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method performed by a computing system that includes one or more computing devices. The method includes obtaining training data including a plurality of triplets. Each triplet includes an example query, an example model reasoning plan associated with the example query, and an example recommendation response associated with the example query and the example model reasoning plan. The method includes providing a first portion of the training data to a sequence processing model as an input training example and receiving at least one output, comparing the at least one output to a second portion of the training data to generate at least one evaluation component, and modifying the sequence processing model based at least in part on the evaluation component.

Another example aspect of the present disclosure is directed to a computing system that includes one or more processors and one or more computer-readable storage media that collectively store a recommendation system. The recommendation system includes a conversational user interface configured to receive a user query and provide a recommendation response and a machine-learned sequence processing model that has been trained on training data including a plurality of triplets. Each triplet includes an example query, an example model reasoning plan associated with the example query, and an example response associated with the example query and the example model reasoning plan. The machine-learned sequence processing model is configured to receive an input prompt including the user query, a previous conversation history associated with the user query, and a model preamble, generate a reasoning plan for responding to the user query, and generate a model response based at least in part on the user query and the reasoning plan.

Another example aspect of the present disclosure is directed to one or more non-transitory computer-readable storage media that store instructions that, when executed by one or more processors, cause the one or more processors to perform operations. The operations include obtaining training data including a plurality of triplets. Each triplet includes an example query, an example model reasoning plan associated with the example query, and an example recommendation response associated with the example query and the example model reasoning plan. The operations include providing a first portion of the training data to a sequence processing model as an input training example and receiving at least one output, comparing the at least one output to a second portion of the training data to generate at least one evaluation component, and modifying the sequence processing model based at least in part on the evaluation component.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram depicting an example computing environment including a conversational recommendation system according to example embodiments of the present disclosure;

FIG. 2 is a block diagram depicting an example conversational recommendation system and processing of a user query according to example embodiments of the present disclosure;

FIG. 3 is a block diagram depicting an example of a model training system for a machine-learned conversational recommendation model according to example embodiments of the present disclosure;

FIG. 4 is a block diagram depicting an example of a model training system for a machine-learned conversational recommendation model according to example embodiments of the present disclosure;

FIG. 5 is a flowchart diagram depicting an example method of training a machine-learned conversational recommendation model according to example embodiments of the present disclosure;

FIG. 6 is a flowchart diagram depicting an example method of training a machine-learned conversational recommendation model according to example embodiments of the present disclosure;

FIG. 7 is a flowchart diagram illustrating an example method for training a machine-learned model according to example implementations of aspects of the present disclosure;

FIG. 8 is a block diagram of an example processing flow for using machine-learned model(s) to process input(s) to generate output(s) according to example embodiments of the present disclosure;

FIG. 9 is a block diagram of an example sequence processing model according to example embodiments of the present disclosure;

FIG. 10 is a block diagram of an example technique for populating an example input sequence for processing by a sequence processing model according to example embodiments of the present disclosure;

FIG. 11 is a block diagram of an example model development platform according to example embodiments of the present disclosure;

FIG. 12 is a block diagram of an example training workflow for training a machine-learned model according to example embodiments of the present disclosure;

FIG. 13 is a block diagram of an inference system for operating one or more machine-learned model(s) to perform inference according to example embodiments of the present disclosure;

FIG. 14 is a block diagram of an example networked computing system according to example embodiments of the present disclosure;

FIG. 15 is a block diagram of an example computing device according to example embodiments of the present disclosure; and

FIG. 16 is a block diagram of an example computing device according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

### Overview

Generally, the present disclosure is directed to machine-learning systems and methods for conversational recommendation systems, such as conversational chatbots that are configured to process user queries and generate responses using natural language. A conversational recommendation system is provided that includes a machine-learned system having one or more conversational recommendation models. A conversational recommendation model can include a sequence processing model such as a large language model that is configured to provide a conversational user interface for receiving user queries and generating responses. More particularly, the conversational recommendation model can be trained to provide conversational-based recommendations using a multi-stage recommendation process that includes a planning stage, a conversation stage, and a retrieval stage. The conversational recommendation model can be trained using training data that includes training triplets. Each training triplet can include an input query, an internal model reasoning plan, and a model response to the input query. The internal model reasoning plan can include an indication of a conversation goal, a summarization of established facts, analysis and deductions to fulfill the intent of the user query, a list of considerations, and a plan to fulfill the user's intent. By training on triplets that include internal model reasoning, the model can be configured to plan a user conversation that will solicit and provide relevant information to fulfill the user's intent.

Traditional conversational recommendation systems, such as those deployed for online shopping chatbots and the like, provide limited assistance in determining a recommendation's suitability for a particular user. These systems do not provide an intuitive or versatile way to refine shopping queries beyond pre-implemented filters that are often specific to the source of a product or service. In many instances, these systems require users to conduct research or possess prior knowledge in order to find the right recommendation. In traditional recommendation systems that employ large language models, recommendations are provided without full consideration of information to solicit from a user and information to provide to a user. These systems do not provide multi-turn planning to facilitate a conversation that can solicit and provide the information most relevant to fulfilling user intent. Further, these systems are only capable of remembering a limited number of conversation turns, leading to limitations for context length. These factors lead to systems that often do not provide recommendations in full accordance with a user's intent. Moreover, the poor responses provided by these systems can lead to user's reformulating and submitting many different queries in an effort to receive a satisfactory response. Large amounts of power and computing capacity can be used by these systems in order to process multiple queries before providing a suitable response.

According to example embodiments of the present disclosure, a conversational recommendation system is provided that is trained to analyze a conversation and devise a reasoning plan before generating a recommendation response at each conversational turn or step. By training the model to generate a reasoning plan, the conversational recommendation system demonstrates high performance in planning a conversation, soliciting information relative to user needs and requirements, providing information to educate the user about options, conducting research (e.g., product research), and making specific recommendations. Through reasoning-based training, the conversational recommendation model can be configured for a multi-stage recommendation process that includes a planning stage, a conversation stage, and a retrieval stage.

According to an example aspect of the present disclosure, a conversational recommendation system can be implemented as or as part of a chatbot-based product or service recommendation, such as an online chatbot that facilitates conversational-based shopping. A chat-style interface can provide an immersive experience for user interactions for obtaining information via a web platform. The systems and methods may be utilized to determine search results (e.g., product or service recommendations) that are responsive to an intent of a multi-turn chat session. A conversational recommendation model can be trained to plan multiple conversational turns in a planning stage. During a conversational stage, the model can learn a user's needs, requirements, or other intent-based information and educate the user about products and services, such as comparisons between options. In a retrieval stage, the model can lookup external information from memory, databases, and/or other computing services. The model can provide recommendations at one or more conversational turns, such as recommendations for products, recommendations for alternate inquiries, and recommendations for user considerations. The model can be configured to generate or update a reasoning plan at each conversational turn before providing a response.

In the planning stage, the conversational recommendation model can plan a conversation to fulfill the intent of a user query. The conversational recommendation model can generate a reasoning plan for a conversation responsive to the user query. The model can generate the reasoning plan to plan one or more future turns for the conversation. The model can generate the plan to determine more information relative to the user query, such as to learn more information about a user in order to provide a product recommendation. Additionally, the model can generate the plan to provide information to the user at one or more conversational turns.

In the conversation stage, the model can learn about the user providing the user query and provide information to the user. The model can solicit information in accordance with the reasoning plan and provide information to the source of the user query, such as to the user submitting the user query. The model can solicit and provide information in accordance with the reasoning plan generated during the planning stage.

In the retrieval stage, the model can access external computing services to determine information relative to the user query, and/or the model can access one or more memories to retrieve information relative to the user query, such as previously stored user data. The conversational recommendation model can provide one or more recommendations that are tailored to the user at one or more conversational turns.

According to example aspects of the present disclosure, a conversational recommendation model can be trained to generate both a reasoning plan and a recommendation response at one or more conversational turns. In accordance with an example embodiment, the conversational recommendation model can be trained using training data with training examples that each include a data triplet. The training data can be manually generated, for example, using expert human writers, and/or can be synthetically generated using a large language model. A training example triplet can include previous conversation turns, an internal model reasoning plan, and a recommendation response. The previous conversation turns can include any previous user queries and responses generated by the model, as well as the current user query. The model reasoning plan can be generated in the form of thoughts. The thoughts can include a restatement of the goal of the conversation and a summarization of established facts during the conversation. The thoughts can also include an analysis and deduction to fulfill a user's intent, considerations for fulfilling the user's intent, and a plan for fulfilling the user's intent. The recommendation response can include, but are not limited to, an indication of an objective from the user query, an indication of relevant and established facts associated with the user query, an indication of key consideration points, one or more recommendations and a justification for each recommendation, or one or more follow-up questions or invitations.

In accordance with example embodiments of the present disclosure, a conversational recommendation model can be trained using one or more loss components based on the triplet training data. By way of example, supervised fine-tuning can be used to train the model to reason and construct responses relevant to a user query. In some examples, an evaluation component such as a loss component can be used to train the model based on the training triplets. For instance, the example query from the triplet can serve as the input training example and the example model reasoning plan and the example recommendation response can serve as the output training example. The input training example can be input to the model to generate a generated model reasoning plan and a generated recommendation response. The generated plan and response can be evaluated against the output training example including the example model reasoning plan and example recommendation response.

In another example, each triplet can be processed to generate two input/output training pairs. A first training pair can include a user query as an input training example and a model reasoning plan as an output training example. A second training pair can include the user query and the model reasoning plan as the input training example and the example recommendation response as the output training example. One or more losses can be calculated by evaluating a generated reasoning plan against the example reasoning plan. One or more losses can also be calculated by evaluating a generated recommendation response against the example response. The loss(es) can be backpropagated to the conversational recommendation model to modify one or more parameters (e.g., weights) of the model. If multiple losses are calculated, they can be backpropagated separately for training or combined prior to backpropagation for training.

According to example aspects of the present disclosure, a conversational recommendation system can include a conversation data store or other memory configured to facilitate arbitrarily long conversations using the conversational recommendation model. The conversation data store can include a database or other storage system configured to store data such as factual information, statements, or other information that the model may need to access during the conversation in order to fulfill the user's intent. In accordance with example embodiments, the conversational recommendation model can be configured to request and save information at each conversational turn. At each conversational turn, the model can request prior information from memory. By way of example, an embedding-based similarity search can be used to identify information in memory that is relevant to a current user query. At each conversational turn, the model can also save data such as factual information that it may later retrieve. In some examples, the model can be trained to extract and save factual information as independent clauses.

According to example aspects of the present disclosure, a conversational recommendation system can be configured to interact with one or more external computing services such as search engines, shopping engines, video hosting services, etc. These services can be local computing services such as first-party computing services or remote computing services such as third-party computing services. A conversational recommendation model can be trained to generate computer-executable code (e.g., code snippets) to interact with the external computing services. For example, the recommendation model can generate code to retrieve product reviews from a website or to retrieve different products available at a particular price point, etc.

In accordance with example embodiments of the present disclosure, a conversational recommendation system can include a prompt generator that is configured to generate one or more prompts for input to the recommendation model based on a user query. By way of example, an input prompt can include a model preamble, a conversation history, and a current user query. The model preamble can include contextual information such as a listing of external computing services available to the model, memory available to the model, instructions for the model to reason at each conversation turn, etc.

According to example embodiments of the disclosed technology, a server computing system, such as a cloud computing system, can host or otherwise implement a conversational recommendation system that is available to one or more user computing devices over one or more computer networks. The conversational recommendation system can provide a user interface that facilitates a natural language interface with one or more machine-learned recommendation models. The conversational recommendation system can implement a chatbot such as a shopping chatbot, travel chatbot, code editing chatbot, or other conversational agent that is configured to receive user queries and generate recommendation responses. A recommendation response can include a product recommendation, service recommendation, music or video recommendation, or any other recommendation.

Systems and methods in accordance with example embodiments of the present disclosure provide a number of technical effects and benefits. In particular, the systems and methods can include a computing system implementing a conversational recommendation system having a recommendation model that is trained to generate recommendation responses and an internal model reasoning plan to fulfill a user's intent in relation to a user query. The conversational recommendation model is trained to plan a conversation, learn user needs and requirements, provide information to the user relative to different recommendation options, conduct research, synthesize findings using up-to-date databases, and make specific product recommendations. The model can be trained to analyze a conversation and generation a model reasoning plan at each conversation turn before generating a response. To facilitate the generation of a model reasoning plan, the model can be trained using triplet training examples that include an input query, model reasoning plan, and recommendation response. Supervised fine-tuning can be used to train the model to construct reasoning plans and recommendation responses for input queries.

As an example technical effect and benefit, the systems and methods in accordance with the disclosed technology can reduce power consumption and compute relative to traditional recommendation systems. Embodiments of the disclosed technology can more accurately determine user intent from a user query and generate a conversational plan to reduce the overall number of queries that are processed. The systems and methods in accordance with the disclosed technology facilitate model reasoning at conversational turns so as to solicit and provide information to more accurately fulfill a user's intent. In this manner, the system can generate a response that fulfills a user intent using a reduced number of inputs to the machine-learned model. As a result, the processing, memory, and power consumption associated with the conversational recommendation system can be reduced.

In example implementations, a conversational recommendation model can include a sequence processing model such as a large language model (LLM). Much of the following disclosure refers to large language models as specific examples of sequence processing models but it will be appreciated that the disclosure is equally applicable to any type of sequence processing model. For example, the disclosed technology can be used with large image models, multimodal models, and other types of foundational models. For instance, the core sequence processing models can operate in domains other than the text domain, such as image domains, audio domains, biochemical domains, etc. For instance, a sequence processing model may be used to process sequential inputs for robotic controls and other tasks. Similarly, the core model and/or the downstream applications can be configured to perform any number of tasks. For instance, if the inputs to the core model and/or a downstream application are images or features that have been extracted from images, the output generated by the core model and/or the downstream application for a given image can be scores for each of a set of object categories, with each score representing an estimated likelihood that the image contains an image of an object belonging to the category. As another example, if the inputs to the core model and/or a downstream application are sensor data, the outputs can be robotic control signals.

As another example, if the input to the core model and/or a downstream application is a sequence of text from a received communication, the output generated may be a score for each of a set of possible responses to the received communication, with the score representing an estimated likelihood that the response matches a user's intent.

As another example, if the input to the core model and/or a downstream application is indicative of a particular function to be performed by an apparatus (such as a robot), the output generated may be a score for each of a set of possible control signals for controlling the apparatus, with the score representing an estimated likelihood that the control signals match the particular function to be performed.

As another example, if the input to the core model and/or a downstream application includes natural language indicative of a computer implemented operation, the output generated may be a score for each of a set of possible computer readable code segments, with the score representing an estimated likelihood that the computer readable code segments match the computer implemented operation.

As another example, if the input to the core model and/or a downstream application is a sequence of text in one language, the output generated may be a score for each of a set of pieces of text in another language, with each score representing an estimated likelihood that the piece of text in the other language is a proper translation of the input text into the other language.

Although a number of examples of tasks which may be performed by the core model and/or a downstream application are provided here, it will be understood that this is not exhaustive, and that the core model and/or the downstream applications can be configured to perform any suitable task.

With reference now to the Figures, example embodiments of the present disclosure will be discussed in further detail.

### Example System and Model Arrangements

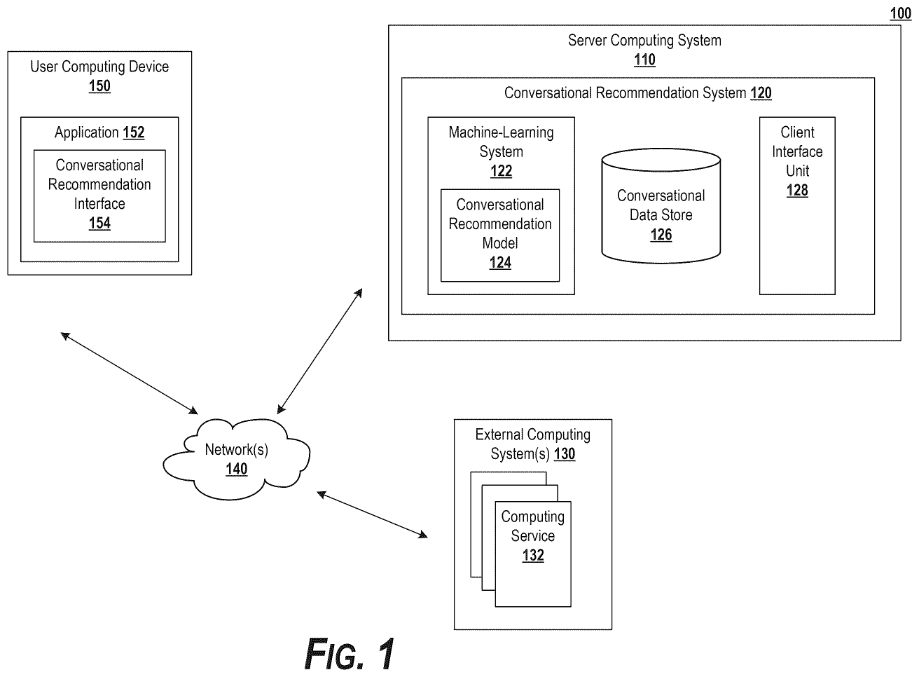

FIG. 1 is a block diagram depicting an example computing environment 100 including a server computing system 110 that hosts or otherwise implements a conversational recommendation system 120 that can be accessed by user computing devices such as user computing device 150 executing an application 152. Computing environment 100 includes one or more external computing systems 130 that host or otherwise implement one or more computing services 132 accessible to server computing system 110 and/or user computing device 150. Although a single user computing device is shown, any number of user computing devices may access the server computing system 110.

In some examples, server computing system 110 may be implemented by a first computing system, external computing system 130 can be implement by another computing system, and each user computing device 150 can be implemented by a different remote computing system. For instance, computing environment 100 may be implemented as a client server computing environment, including one or more client computing devices implementing each of the user computing devices 150 and one or more server computing devices implementing server computing system 110 and external computing system(s) 130. In another example, one or more of the downstream applications can be implemented at a server computing system.

The computing systems implementing server computing system 110, user computing device 150, and external computing systems 130 can be connected by and communicate through one or more networks 180. Any number of user computing devices and/or server computing devices can be included in the client-server environment and communicate over a network. The network can be any type of communications network, such as a local area network (e.g., intranet), wide area network (e.g., Internet), or some combination thereof. In general, communication between the computing devices can be carried via a network interface using any type of wired and/or wireless connection, using a variety of communication protocols (e.g., TCP/IP, HTTP, RTP, RTCP, etc.), encodings or formats (e.g., HTML, XML, etc.), and/or protection schemes (e.g., VPN, secure HTTP, SSL, etc.).

In example embodiments, a user computing device 150 implementing a downstream application 152 can be any suitable device, including, but not limited to, a smartphone, a tablet, a laptop, a desktop computer, or any other computer device that is configured such that it can allow a user to access remote computing devices over a network. The user computing devices can include one or more processor(s), memory, and a display as described in more detail hereinafter. The user computing devices can execute one or more client applications such as a web browser, email application, chat application, video conferencing application, word processing application or the like.

The server computing system 110 can include one or more processor(s) and memory implementing conversational recommendation system 120. The server computing system 110 can be in communication with the one or more user computing device(s) 150 using a network communication device that is not pictured.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Server computing system 110 can include or otherwise implement a conversational recommendation system 120 including a machine-learning system 122, conversation data store 126, and client interface unit 128.

Application 152 can be any suitable application for accessing and displaying content from server computing system 110. For example, application 152 can be a web browser application or dedicated application that can render data received from conversational recommendation system 120, receive user input, and provide user input data to conversational recommendation system 120.

Client interface unit 128 can implement one or more application programming interfaces to receive data from and provide data to user computing devices 150, enabling users to access the conversational recommendation system using an application 152. In some examples, client interface unit 128 can generate computer-executable interface code to render conversational recommendation interface 154 at user computing device 150. The conversational recommendation interface 154 can include a user interface (UI) such as a graphical user interface (GUI) that can receive user queries and provide responses received from conversational recommendation system 120. The output of conversational recommendation model(s), such as text or executable code generated in response to a prompt, can be provided in the conversational recommendation interface 154. For example, the output of the recommendation model can be used to populate a text cell with text or other sequential data generated in response to the user query. In this manner, the outputs of the machine-learned model can be integrated into the conversational recommendation interface.

Server computing system 110 can implement a machine-learning system 122 including one or more machine-learned conversational recommendation models 124. Conversational recommendation models 124 can include any type of machine-learned sequence processing model. In an example, a sequence processing model can include a large language model (LLM) including 10B parameters or more. In another example, a sequence processing model can include a language model having less than 10B parameters (e.g., 1B parameters). In yet another example, the sequence processing model can include an autoregressive language model. Machine-learning system 122 may include additional machine learned models such as a machine-learned text-to-image model, a machine-learned text-to-video model, a machine-learned text-to-audio model, a machine-learned multi-modal model, or any other machine-learned model configured to provide generative content in response to a user query. The generative content generated by conversational recommendation model 115 can include text data, computer-executable code data, image data, video data, audio data, or other types of generative content. The conversational recommendation model can be trained to process input data to generate output data. The input data can include text data, image data, audio data, latent encoding data, and/or other input data, which may include multimodal data.

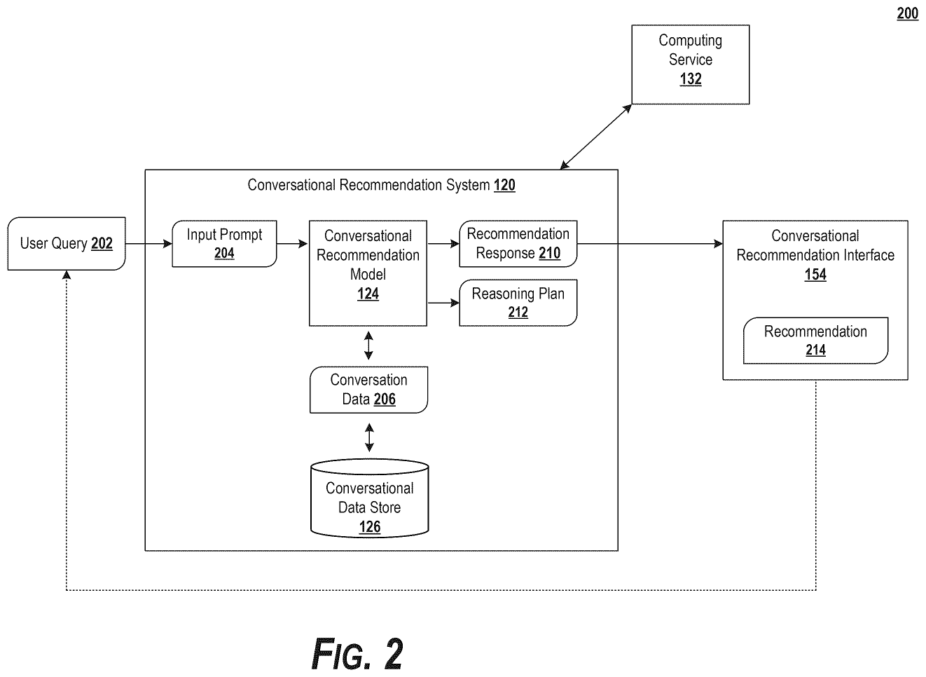

FIG. 2 is a block diagram depicting an example computing environment 200 including a conversational recommendation system 120 according to an example embodiment of the present disclosure. Conversational recommendation system 120 includes one or more machine-learned conversational recommendation models 124 of a machine-learning system including that are configured to respond to user queries by generating recommendation responses.

An example is depicted in FIG. 2 where a user query 202 is processed by the conversational recommendation system to generate a recommendation response. User Query 202 is one example of a possible input that can be received to determine a user intent. The user query can include any type of input data including text data, image data, audio data, video data, sensor data, latent encoding data, etc.. In some examples, the user query can include a multimodal input including two or more types of input data, for example, a text input component and an image input component. The user query 202 can indicate, include, or otherwise represent a target system action (also referred to as a user intent) to be performed in response to the user query. Conversational recommendation system 120 processes the user query 202 to generate a recommendation response 210. Recommendation response 190 is responsive to the user query and can include any type of output data including text data, image data, audio data, video data, sensor data, latent encoding data. Recommendation response 210 is provided to a user computing device which can render a conversational recommendation interface that includes a user interface element including recommendation 214 included in recommendation response.

User query 202 is received by conversational recommendation system 120. Recommendation system 120 formulates an input prompt 204 from the user query. In example embodiments, input prompt 204 can include the user query 202, a conversation history associated with the user query 202, and a model preamble. The conversation history can include any previous user queries and model responses associated with the current user query. The model preamble can provide additional context to the recommendation model for responding to the user query. The model preamble can include an indication of external computing services such as code extensions that are available to the recommendation model. The preamble can include an indication of one or more memories available to the user to read from and write to. The preamble can indicate to the model that it can reason and generate a reasoning plan about the conversation, which can be maintained in its “thoughts.” The preamble can indicate to the model that the thoughts will not be provided to the user issuing the query.

Input prompt 204 is provided as an input to conversational recommendation model 124. In response to the input prompt 204, conversational recommendation model 124 generates one or more recommendation responses 210 and one or more model reasoning plans 212. Model 124 is configured to access conversation data store 126 to retrieve previously determined information relative to the current conversation and/or to write information for later retrieval during subsequent conversational turns. Conversational recommendation model can read and/or write conversation data 206 to the conversation data store 126.

Based on the input prompt 204 and optional conversation data 206, conversational model 124 can generate the one or more model reasoning plans 212 in accordance with its training to generate a reasoning plan at each conversational turn. After generating the reasoning plan, the conversational model 124 can generate the one or more recommendation responses 210 based on the input prompt 204, the reasoning plan 212, and optional conversation data 206. Model 124 can optionally access one or more external computing services 132 to generate reasoning plan 112 and/or recommendation response 210.

Conversational recommendation system 120 can provide the recommend response 210 to one or more user computing devices (not shown) rendering a conversational recommendation interface 154. The conversational recommendation interface 154 can be updated to display or otherwise provide the recommendation response 210 to the user.

FIG. 2 depicts a single conversational turn that can occur in response to a user query 202. After providing the recommendation response, the system can receive an additional user query 202. For example, the user may provide one or more inputs using the recommendation user interface to provide an additional user query 202 to the conversational recommendation model 120 in relation to the ongoing conversation. Recommendation system 120 can repeat the described process to process the additional user query 202. This process can be repeated any number of times.

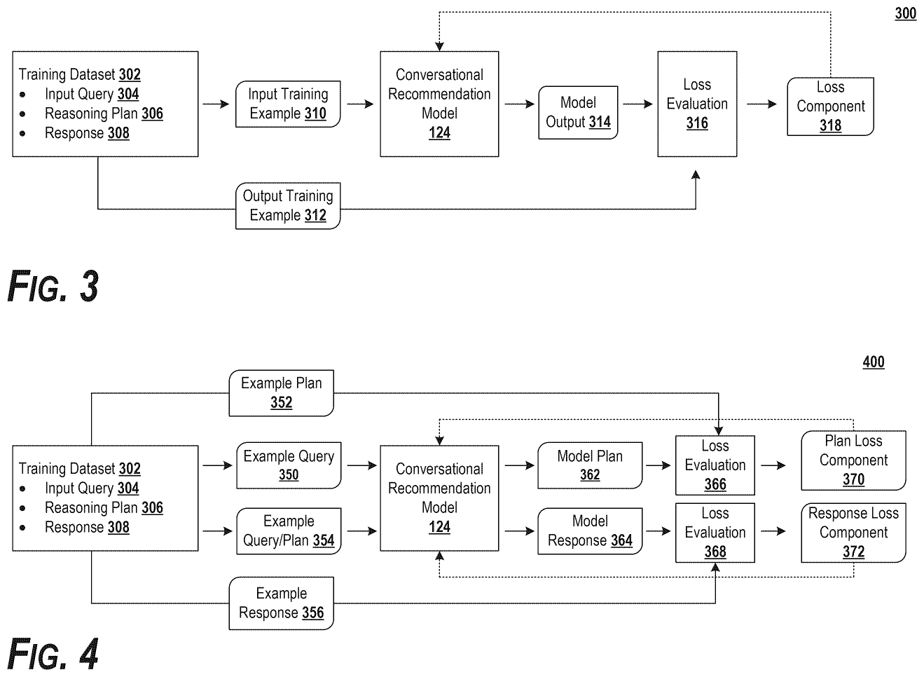

FIG. 3 is a block diagram depicting an example computing environment including a conversational recommendation model training system 300 according to example embodiments of the present disclosure. In particular, a training dataset 302 is provided that includes a plurality of training examples that can be obtained to train and/or retrain a conversational recommendation model 124. According to example aspects of the present disclosure, each training example can include a data triplet (also referred to as triplet) that includes a user query 304, a model reasoning plan 306, and a model response 308. The training data may be referred to as training data or example data. Each triplet can be provided to the conversational recommendation model 124 to generate a model output 314. A loss function can be evaluated by a loss evaluation 316 component to generate a loss component 318, which can be backpropagated to the conversational recommendation model 124 to adjust or modify one or more parameters (e.g., weights) of the recommendation model.

According to example aspects of the present disclosure, each data triplet can be divided into at least one input training example 320 and at least one output training example 330. The input training example 310 can be provided to and processed by the conversational recommendation model 124 to generate at least one output 314. For example, a training triplet can be divided into an input training example 310 that includes the user query 304 portion of the triplet and an output training example 312 that includes the model reasoning plan 306 and the model response 308. In such an example, the user query 304 can be provided to the model 124 which generates a model reasoning plan and a model response as one or more model outputs 314. The generated model reasoning plan can be compared with the training example reasoning plan 306 and/or the model response can be compared with the training model response 308. A first loss can be determined based on the evaluation of the model reasoning plan and a second loss can be determined based on the evaluation of the model response. The first loss and the second loss can be backpropagated separately to train the model or the first loss and the second loss can be combined into a combined loss which can be backpropagated to train the model.

In another example, a training triplet can be divided into an input training example 310 that includes the user query 304 portion and the model reasoning plan 306 portion of the triplet and an output training example 312 that includes the model response 308. In such an example, the user query 304 and the model reasoning plan 306 can be provided to the model as an input training example 310 and the model can generate a model response as model output 314. The model output 314 response can be compared with the training example model response 308. A loss component 318 can be determined based on the evaluation of the model response relative to the example model response 308. The loss component 318 an be backpropagated to train the model. Other examples of training the model using a triplet including a user query, model reasoning plan, and model response can be used.

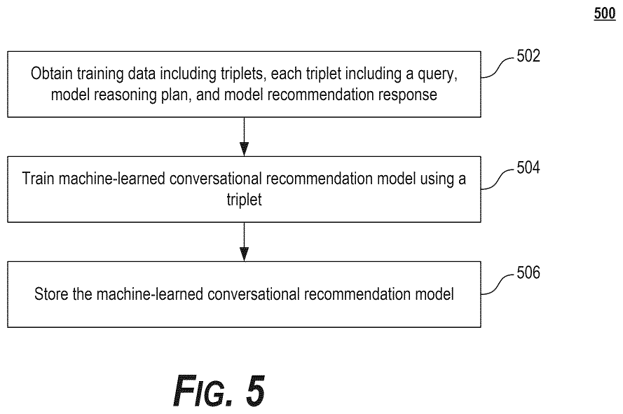

FIG. 4 is a block diagram depicting an example computing environment including conversational recommendation model training system 400 according to example embodiments of the present disclosure. In this particular example, each training data triplet from training dataset 302 is divided or split into two input/output training pairs. A first training pair of each triplet includes the example user query 304 as the input training example and the example model reasoning plan 3306 as the output training example. A second pair of each triplet includes the example user query 304 and the example model reasoning plan 306 as the input training example and the model response 308 as the output training example. An input training example 350 including the example query 304 can be processed by the conversational recommendation model 124 to generate an output including a generated model reasoning plan 362. A first loss evaluation 366 can be performed by evaluating a loss function based on a comparison between the generated model plan 362 and the example model plan 306. The evaluation can be used to generate a plan loss component 370 which can be backpropagated to the conversational recommendation model to adjust or modify one or more parameters of the conversational recommendation model.

An input training example 354 including the example user query 304 and the example model reasoning plan 306 can be processed by the conversational recommendation model 124 to generate an output including a generated model response 364. A second loss evaluation 368 can be performed by evaluating a loss function based on a comparison between the generated model response 364 and the example model response 308 from output training example 356. The evaluation can be used to generate a response loss component 372 which can be backpropagated to the conversational recommendation model to adjust or modify one or more parameters of the conversational recommendation model.

According to an example implementation of the present disclosure, both training pairs for a particular triplet can be used to train the model before training with the next triplet. The plan loss component and the response loss component can be calculated for each training example and backpropagated to train the model. In another example, the model can be trained using the first pairs from each training triplet, followed by training the model using the second pairs from each training triplet. It is noted that the training triplets can be divided or split into other training formats in other examples.

### Example Methods

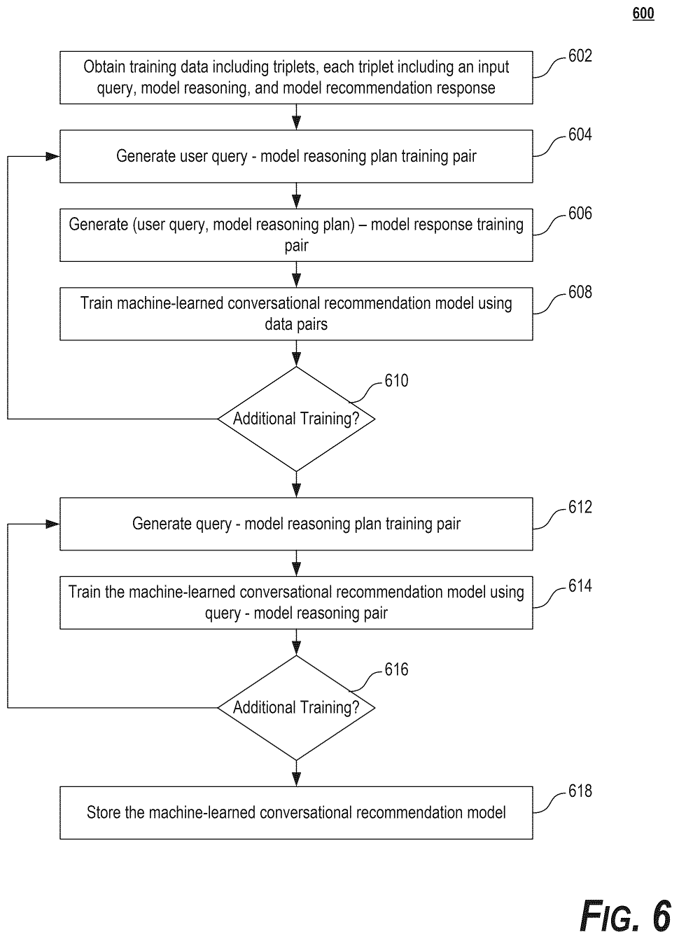

FIG. 5 is a flowchart diagram depicting an example method of training a machine-learned conversational recommendation model according to example embodiments of the disclosed technology. One or more portion(s) of example method 500 and the other methods described herein can be implemented by a computing system that includes one or more computing devices. By way of example, one or more portions of example method 500 can be performed by a conversational recommendation system including a model trainer for training a conversational recommendation model. The conversational recommendation model can include a sequence processing model such as a large language model as described herein. Each respective portion of the example methods can be performed by any (or any combination) of one or more computing devices. Moreover, one or more portion(s) of the example method 500 can be implemented on the hardware components of the device(s) described herein, for example, to train a recommendation to generate reasoning plans. The methods in the figures may depict elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. The example methods are described with reference to elements/terms described with respect to other systems and figures for exemplary illustrated purposes and are not meant to be limiting. One or more portions of the example methods can be performed additionally, or alternatively, by other systems.

At 502, method 500 can include obtaining a training dataset. The training dataset can include a plurality of training examples. In example embodiments, each training example can include a data triplet including an example query, an example model reasoning plan, and an example model response.

At 504, method 500 can include training the machine-learned recommendation model using a triplet from the plurality of training examples. Various options can be used to train the model at 504 using a data triplet. In one example, an input training example can be formed from the user query of a triplet and an output training example can be formed from both the model reasoning plan and the model response from the triplet. The user example from the first pair can be provided as an input training example to generate a generated model reasoning plan and a model response. The model can be trained using a loss determined by comparing the generated model reasoning plan with the training reasoning plan from the output example and/or by comparing the generated model response with the training model response from the output example. In such an example, the model can be trained using a single loss component to reason and plan (generate a reasoning plan) as well as to generate a response based on a reasoning plan.

In other examples, training the model using a triplet at 506 can include dividing the training triplet into two input/output training pairs for each triplet. For example, a first training pair can include a user query as the input training example and a model reasoning plan as the output training example. A second training pair can include a user query and a model reasoning plan as the input training example and the model response as the output training example. The user example from the first pair can be provided as an input training example to generate a generated model reasoning plan. The model can be trained using a loss determined by comparing the generated model reasoning plan with the output training example from the first pair. Training using the user query as an input example and a reasoning plan as an output example can train the model to reason and plan. The user query and the model reasoning plan from the second pair can be provided as an input training example and processed by the model to generate a generated model response. The model can be trained using a loss determined by comparing the generated model response with the output training example response from the second pair. Training using the user query and the thought as an input example and a model response as an output example can train the model to generate recommendation responses based on reasoning plans.

Training the model can include evaluating a loss function which can be backpropagated through the model(s) to update one or more parameters of the model(s) (e.g., based on a gradient of the loss function). This may also be referred to as backpropagating a loss through the model. Various loss functions can be used such as mean squared error, likelihood loss, cross entropy loss, hinge loss, and/or various other loss functions. Gradient descent techniques can be used to iteratively update the parameters over a number of training iterations. Alternatively and/or additionally, prompt tuning and/or control token adjustment may be performed based on the evaluating a loss function. In some implementations, performing backwards propagation of errors can include performing truncated backpropagation through time. A number of generalization techniques (e.g., weight decays, dropouts, etc.) can be performed to improve the generalization capability of the models being trained.

At 506, method 500 can include storing the machine-learned conversational recommendation model. The recommendation model can be stored locally and/or at a server computing system. The recommendation model may be stored to be leveraged by one or more web platforms. For example, the trained recommendation model may be utilized for generating one or more search results for a search engine. The generated one or more search results can be provided as a summary and/or example in a separate panel of a search results page and/or adjacent to web search results and/or image search results. Alternatively and/or additionally, the generative model can be stored to be utilized by a chatbot and/or an image-generation bot.

It has been observed that in some examples a model can be efficiently trained to provide accurate responses by first training using data triplets, followed by training using data pairs. For example, a model can be trained to generate responses from user queries and model reasoning plans, followed by additional training to generate model reasoning plans only from user queries. In some instances, a model may be able to more quickly learn to generate model responses from model reasoning plans than to learn to generate model reasoning plans from user queries. In accordance with example embodiments of the present disclosure, a model can be trained with a first subset data triplets to learn to generate responses, followed by training with a second subset of data triplets including data pairs to learn to generate model reasoning plans. By training with data pairs only with the second subset, computing resources can be preserved while maintaining model quality.

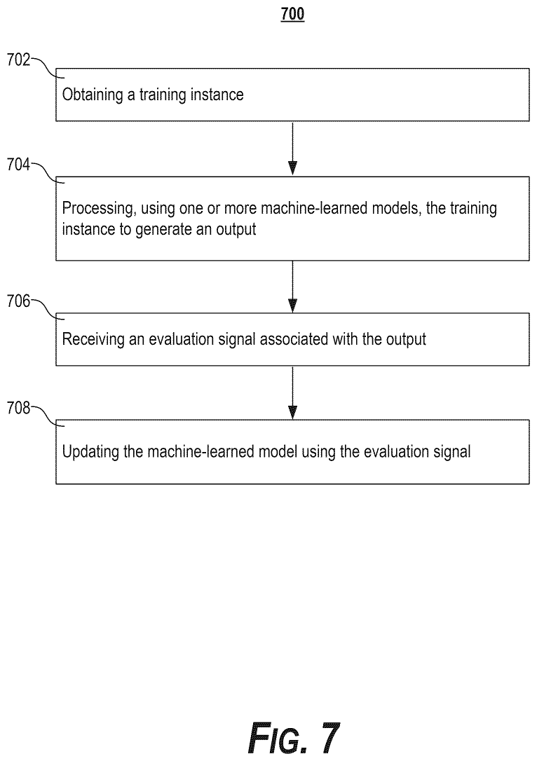

FIG. 6 is a flowchart diagram depicting an example method of training a machine-learned conversational recommendation model according to example embodiments of the disclosed technology.

At 602, method 600 can include obtain a training dataset. The training dataset can include a plurality of training examples. In example embodiments, each training example can include a data triplet including an example query, an example model reasoning plan, and an example model response.

At 604 and 606, method 600 can include dividing or splitting one or more training triplets into two training pairs. Each triplet can be split into two input/output training pairs. At 604 for example, method 600 can include dividing the triplet to generate a first training pair including a user query as the input training example and a model reasoning plan as the output training example. At 606 for example, method 600 can include dividing the triplet to generate a second training pair including the user query and the model reasoning plan as the input training example and the model response as the output training example.

At 608, method 600 can include training the machine-learned recommendation model using a triplet from the plurality of training examples. Training the model using a triplet at 608 can include training the model using the multiple training pairs derived from each triplet. The user example from the first pair can be provided as an input training example to generate a generated model reasoning plan. The model can be trained using a loss determined by comparing the generated model reasoning plan with the output training example from the first pair. The user query and the model reasoning plan from the second pair can be provided as an input training example and processed by the model to generate a generated model response. The model can be trained using a loss determined by comparing the generated model response with the output training example response from the second pair. In some examples, the two losses calculated for each triplet can be backpropagated to the model to train the model separately with each loss. In other examples, the two losses can be combined and the combined loss backpropagated to train the recommendation model.

At 610, method 600 can include determining whether additional training is to be performed using data triplets from the training data. For example, the system can be configured to train the model using a predetermined number of data triplets. In another example, the system can be configured to train the model using data triplets until one or more model performance metrics satisfy one or more criteria (e.g., a threshold). For instance, the model can be trained using data triplets until the generated model response meets a performance criteria (e.g., quality level) relative to the training model response.

If additional training using data triplets is to be performed, method 600 can continue at 604 by selecting another data triplet and repeating the training process. As earlier noted, training using triplets can including training using a first training pair from multiple triplets followed by training using a second training pair from multiple triplets. In other examples, training using triplets can include training using both the first and second training pairs from a triplet before training using another triplet.

If training using data triplets has been completed, method 600 can continue at 612. At 612, method 600 can include dividing a triplet into a first training pair including a user query as the input training example and a model reasoning plan as the output training example.

At 614, method 600 can include training the machine-learned recommendation model using data training pairs only. More particularly at 614, method 600 can include training only with input training examples that include a user query and an output training examples that includes a model reasoning plan. The user query from a training data triplet can be provided as an input training example to generate a generated model reasoning plan. The model can be trained using a loss determined by comparing the generated model reasoning plan with an output training example including the example model reasoning plan.

At 616, method 600 can include determining whether additional training is to be performed using data pairs from the training data. For example, the system can be configured to train the model using a predetermined number of data pairs. In another example, the system can be configured to train the model using data pairs until one or more model performance metrics satisfy one or more criteria (e.g., a threshold). For instance, the model can be trained using data pairs until the generated model reasoning plan meets a performance criteria (e.g., quality level) relative to the training model reasoning plan.

If additional training using data pairs is to be performed, method 600 can continue at 612 by generating or otherwise obtaining a data pair including a user query as an input example and a model reasoning plan as an output example.

If additional training using data pairs is not to be performed, method 600 can continue at 618 by storing the machine-learned conversational recommendation model.

In this manner, the recommendation model can first be trained to both reason and plan by generating model reasoning plans and to respond based on reasoning plans (thoughts). The model can then be trained to focus on generating model reasoning plans by limiting training to data pairs including user queries as input examples and model reasoning plans as output examples. It has been discovered that a model may be trained to generate responses using a smaller number of training examples (e.g., 50). Thus, method 600 can be used to train the model to generate responses using data triplets, followed by additional training using data pairs only that focus on training the model to generate training plans. In this manner, fewer computing resources can be used as data triplets are only processed for a limited number of training iterations. Further training can be performed using data pairs only to save computing resources, including power, CPU cycles, and overall training time.

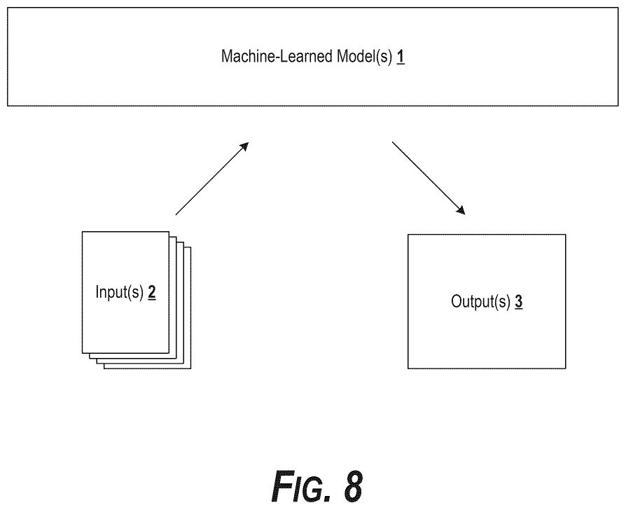

FIG. 7 depicts a flowchart of a method 700 for training one or more machine-learned models according to aspects of the present disclosure. For instance, an example machine-learned model can include a core sequence processing model, such as a foundational large language model (LLM).

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

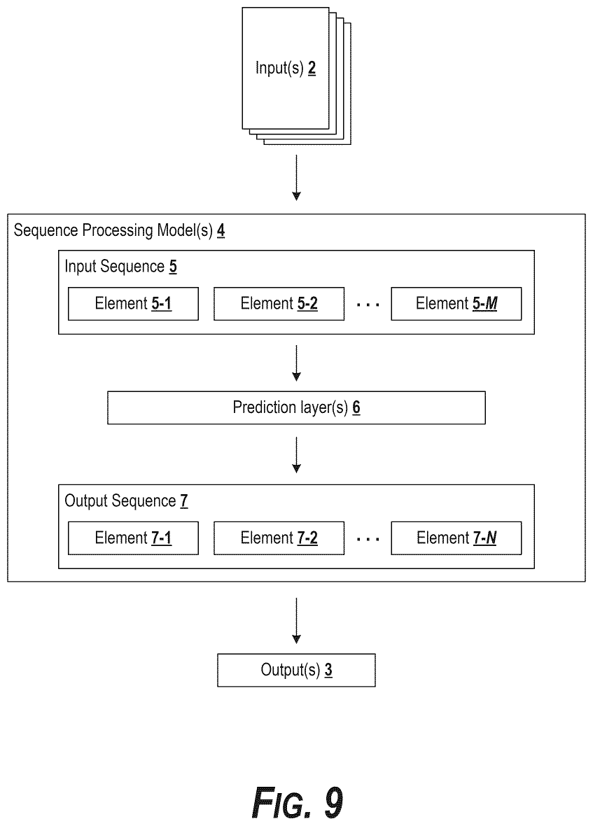

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism, such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

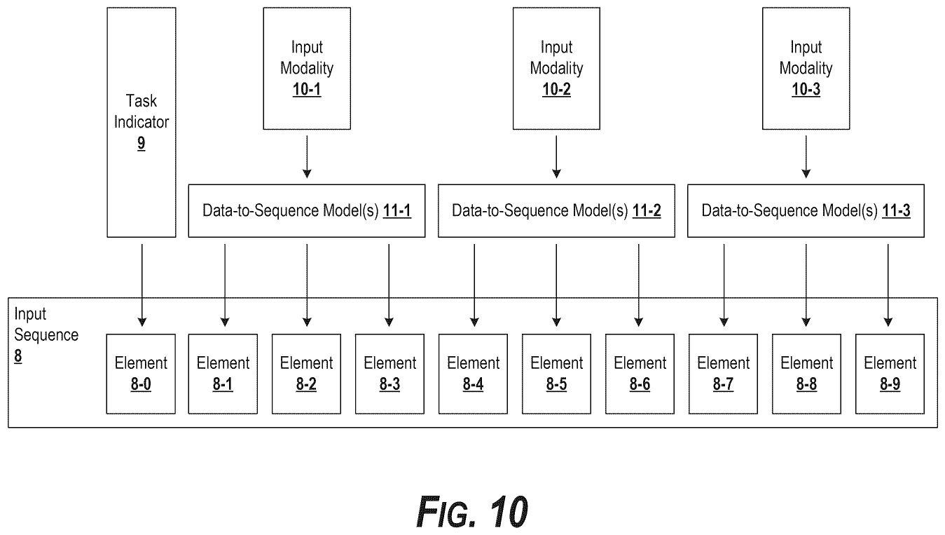

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

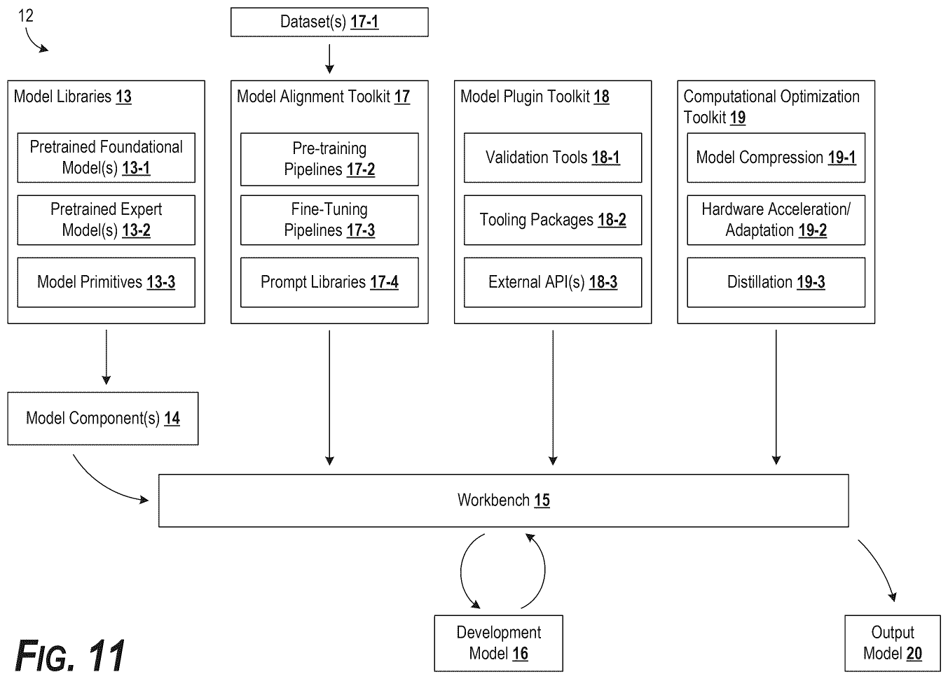

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

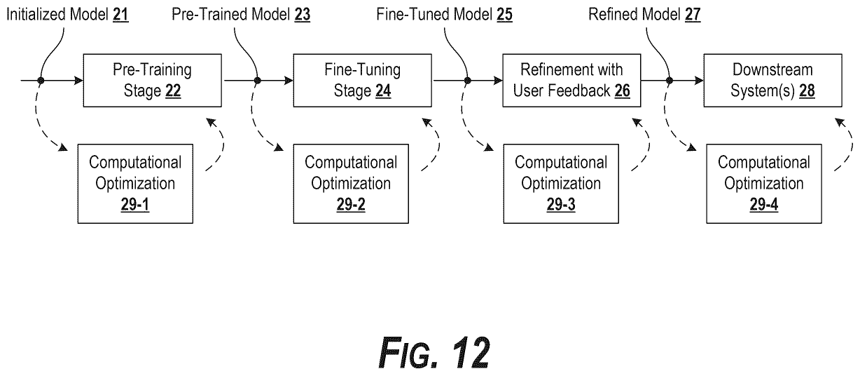

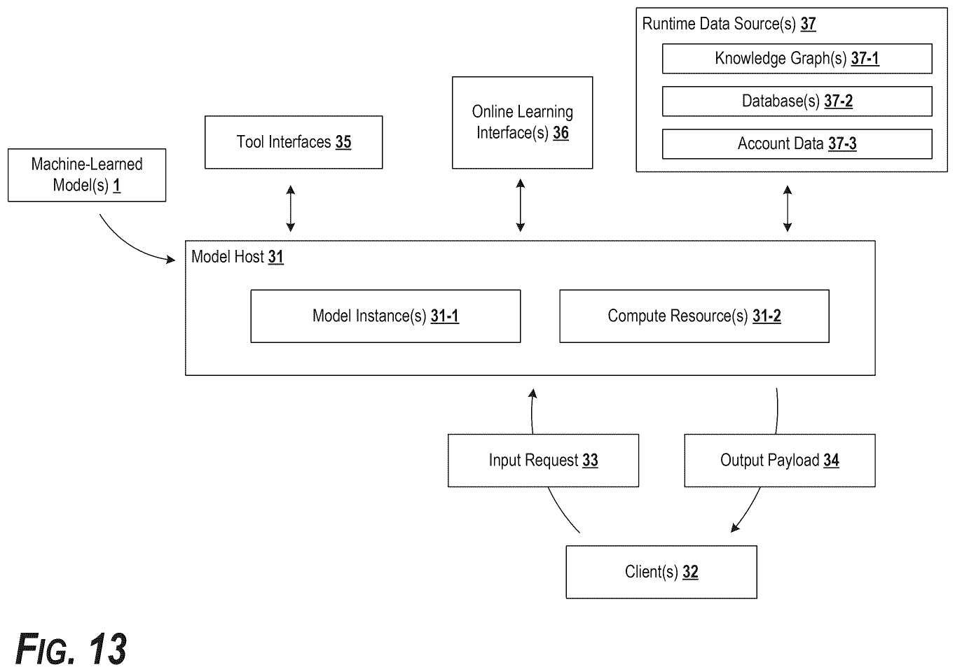

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

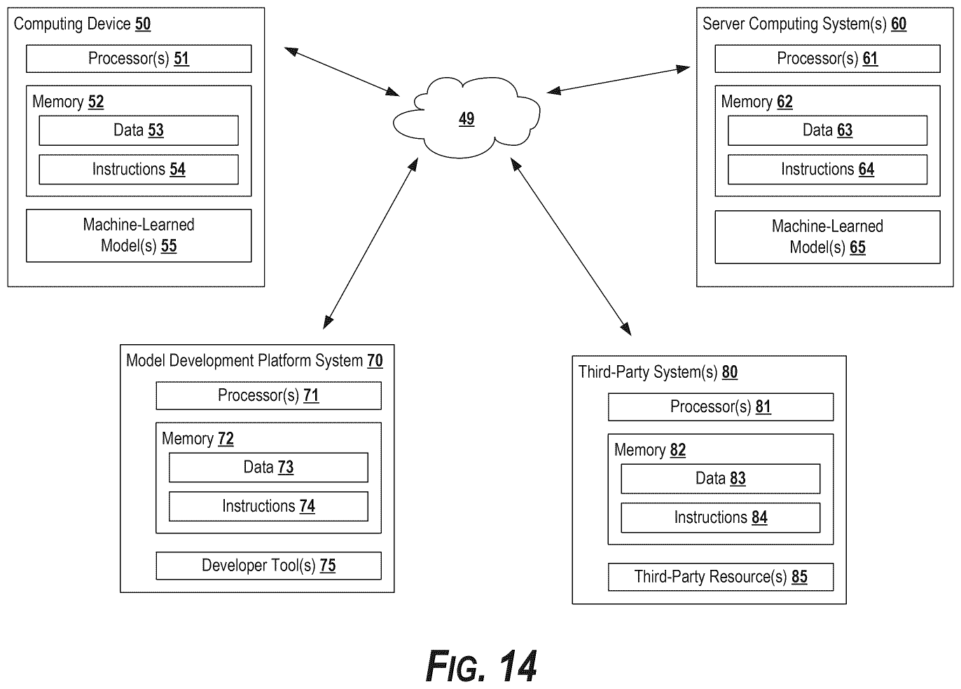

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

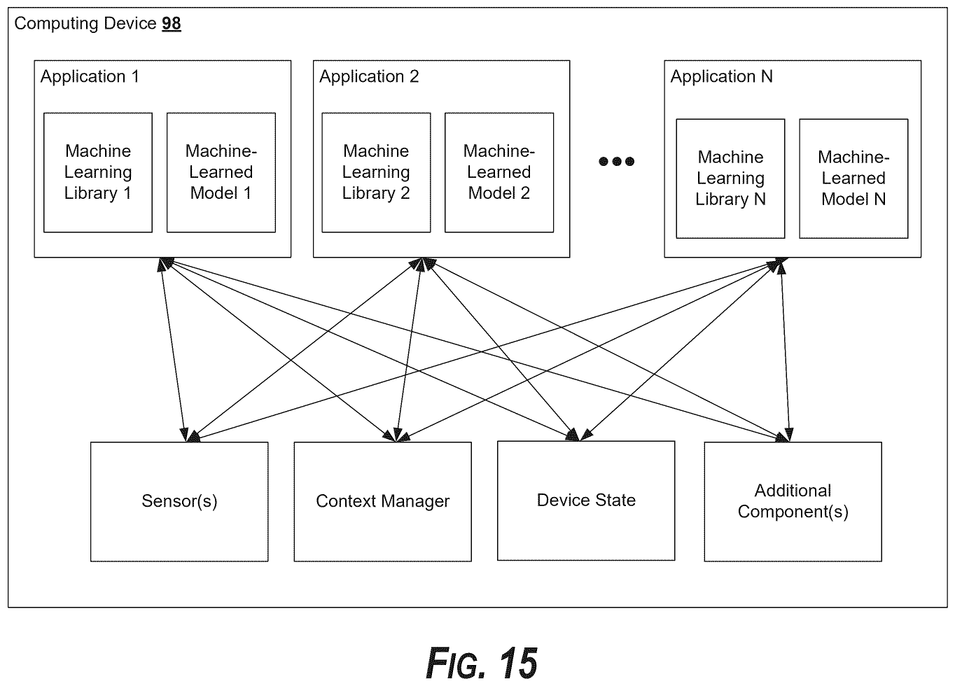

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

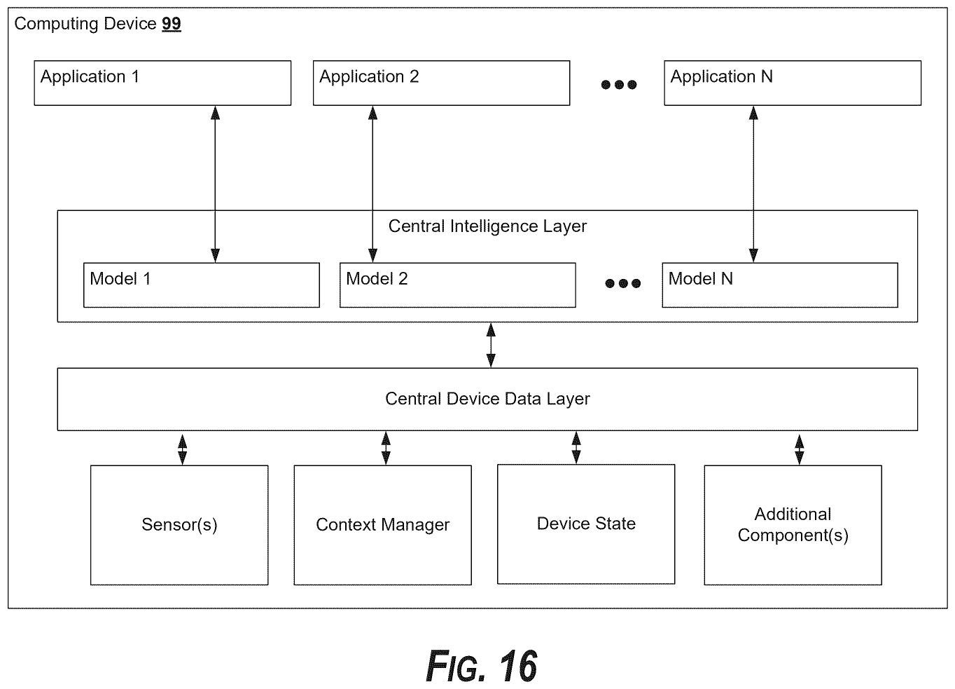

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 16, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, the method comprising:
obtaining, by a computing system comprising one or more computing devices, training data comprising a plurality of triplets, each triplet comprising an example query, an example model reasoning plan associated with the example query, and an example recommendation response associated with the example query and the example model reasoning plan;
providing, by the computing system, a first portion of the training data to a sequence processing model as an input training example and receiving at least one output;
comparing, by the computing system, the at least one output to a second portion of the training data to generate at least one evaluation component; and
modifying, by the computing system, the sequence processing model based at least in part on the at least one evaluation component.

2. The computer-implemented method of claim 1, wherein:
providing, by the computing system, the first portion of the training data to the sequence processing model as an input training example and receiving at least one output, comprises for each triplet of at least a subset of the triplets:
providing the example query to the sequence processing model as a first training example input and receiving a first output including a generated model reasoning plan; and
providing the example query and the example model reasoning plan to the sequence processing model as a second training example input and receiving a second output including a generated model recommendation response.

3. The computer-implemented method of claim 2, wherein comparing, by the computing system, the at least one output to the second portion of the training data to generate the at least one evaluation component output, comprises:
evaluating a first loss component based on comparing the generated model reasoning plan to the example model reasoning plan from the triplet of the training data; and
evaluating a second loss component based on comparing the generated model recommendation response to the example recommendation response from the triplet of the training data;
wherein modifying, by the computing system, the sequence processing model comprises modifying the sequence processing model based at least in part on the first loss component and the second loss component.

4. The computer-implemented method of claim 2, wherein:
the subset is a first subset of the plurality of triplets;
providing, by the computing system, at least a portion of the training data to the sequence processing model and receiving at least one response, comprises, for each triplet of a second subset of the plurality of triplets,
providing the example query to the sequence processing model as a first training example input and receiving a third output including a generated model reasoning plan.

5. The computer-implemented method of claim 4, wherein:
comparing, by the computing system, the at least one output to the second portion of the training data to generate the at least one evaluation component, comprises:
evaluating a third loss component based on comparing the example model reasoning plan to a generated model reasoning plan;
modifying, by the computing system, the sequence processing model comprises, for the second subset of the plurality of triplets, modifying the sequence processing model based on the third loss component without calculating a loss based on a generated model recommendation response.

6. The computer-implemented method of claim 1, wherein:
the sequence processing model is a large language model.

7. The computer-implemented method of claim 1, further comprising:
obtaining, by the computing system, a user query for the sequence processing model;
providing an input prompt to the sequence processing model, the input prompt including the user query, a conversation history associated with the user query, and a model preamble.

8. The computer-implemented method of claim 7 wherein:
the model preamble includes instructions indicative of one or more external tools available to the sequence processing model.

9. The computer-implemented method of claim 1, wherein:
the sequence processing model is configured to read and write data to a conversational data store as part of processing a user query.

10. The computer-implemented method of claim 1, wherein:
the example model reasoning plan of the training data includes data indicative of at least one of:
a goal associated with the example query;
a situation associated with the example query;
a consideration associated with the example query; and
a plan associated with the example query.

11. The computer-implemented method of claim 1, wherein:
the example recommendation response of the training data is associated with at least one model interaction turn for generating at least one recommendation in response to the example query of the training data.

12. A computing system, comprising:
one or more processors;
one or more computer-readable storage media that collectively store a recommendation system, the recommendation system comprising:
a conversational user interface configured to receive a user query and provide a recommendation response;
a machine-learned sequence processing model that has been trained on training data including a plurality of triplets, each triplet comprising an example query, an example model reasoning plan associated with the example query, and an example response associated with the example query and the example model reasoning plan, the machine-learned sequence processing model configured to:
receive an input prompt including the user query, a previous conversation history associated with the user query, and a model preamble;
generate a reasoning plan for responding to the user query;
generate a model response based at least in part on the user query and the reasoning plan.

13. The computing system of claim 12, wherein:
the model response includes at least one of an indication of an objective from the user query, an indication of relevant and established facts associated with the user query, an indication of key consideration points, one or more recommendations and a justification for each recommendation, or one or more follow-up questions or invitations.

14. The computing system of claim 12, wherein:
the machine-learned sequence processing model is configured to, in response to the input prompt:
generate computer-executable code to access one or more external computing services using one or more application programming interfaces.

15. The computing system of claim 14, wherein:
the reasoning plan is based at least in part on the computer-executable code.

16. The computing system of claim 14, wherein:
the model response is based at least in part on the computer-executable code.

17. The computing system of claim 12, wherein:
the machine-learned sequence processing model is configured to, in response to the input prompt:
request, from one or more memories, data associated with one or more previous conversational turns associated with the user query; and
store, in the one or more memories, data associated with a current conversational turn associated with the user query.

18. One or more non-transitory computer-readable storage media that store instructions that, when executed by one or more processors, cause the one or more processors to perform operations, the operations comprising:
obtaining training data comprising a plurality of triplets, each triplet comprising an example query, an example model reasoning plan associated with the example query, and an example recommendation response associated with the example query and the example model reasoning plan;
providing a first portion of the training data to a sequence processing model as an input training example and receiving at least one output;
comparing the at least one output to a second portion of the training data to generate at least one evaluation component; and
modifying the sequence processing model based at least in part on the at least one evaluation component.

19. The one or more non-transitory computer-readable storage media of claim 18, wherein:
providing the first portion of the training data to the sequence processing model as an input training example and receiving at least one output, comprises for each triplet of at least a first subset of the triplets:
providing the example query to the sequence processing model as a first training example input and receiving a first output including a generated model reasoning plan; and
providing the example query and the example model reasoning plan to the sequence processing model as a second training example input and receiving a second output including a generated model recommendation response;
comparing the at least one output to the second portion of the training data to generate the at least one evaluation component, comprises:
determining a first loss component based on comparing the generated model reasoning plan to the example model reasoning plan from the triplet of the training data; and
determining a second loss component based on comparing the generated model recommendation response to the example recommendation response from the triplet of the training data;
wherein modifying the sequence processing model comprises modifying the sequence processing model based at least in part on the first loss component and the second loss component.

20. The one or more non-transitory computer-readable storage media of claim 19, wherein:
providing at least a portion of the training data to the sequence processing model and receiving at least one response, comprises, for each triplet of a second subset of the plurality of triplets,
providing the example query to the sequence processing model as a first training example input and receiving a third output including a generated model reasoning plan;
comparing the at least one output to the second portion of the training data to generate the at least one evaluation component, comprises:
evaluating a third loss component based on comparing the example model reasoning plan to a generated model reasoning plan;
modifying the sequence processing model comprises, for the second subset of the plurality of triplets, modifying the sequence processing model based on the third loss component without calculating a loss based on a generated model recommendation response.
